(19) United States
(12) Patent Application Publication
(10) Pub. No.: US 2005/0228096 A1
(43) Pub. Date: Oct. 13, 2005

(54) Adhesives having barrier properties

(75) Inventors: Christian Kirsten, Burscheld (DE); Claudia Meckel-Jonas, Neuss (DE); Ulrike Brueninghaus, Monheim (DE); Christian Kropf, Hilden (DE)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Henkel Kommanditgesellschaft auf Aktien (Henkel KGaA), Duesseldorf (DE)

(21) Appl. No.: 10/381,830

(22) PCT Filed: Sep. 19, 2001
(86) PCT No.: PCT/EP01/10808

§ 371 Date: Jul. 22, 2003

(30) Foreign Application Priority Data
Sep. 28, 2000 (DE) 100 48 059.4

(51) Int. Cl. C08K 3/18

(52) U.S. Cl. 524/430

(57) ABSTRACT

An adhesive composition and the use thereof to produce barrier-effect composite films. The adhesive composition contains polymer binders and fillers having a platelet-like crystallite structure with an aspect ratio of >100. The composite films produced with this adhesive exhibit barrier characteristics against the migration of oxygen, flavors and water vapor. These films are useful for packaging foods and medicaments.

This invention relates to an adhesive composition with barrier properties, to a process for the production of barrier-effect composite films and to the use of these composite films for packaging.

Many goods require protection against the ambient air or the surrounding atmosphere for transportation or storage while others, particularly those with high water contents, have to be protected against drying out. Accordingly, they have to be packaged in a way which is suitable for keeping out all or certain constituents of the surrounding atmosphere or for stopping diffusion of the water or flavors into the surrounding atmosphere and hence for preventing drying out or changes in the taste of the packaged product. A particularly critical constituent of the surrounding atmosphere is oxygen. With many packaged goods, such as foods or medicaments for example, the presence of oxygen can lead to oxidative spoilage or to the growth of germs which can also spoil the packaged product.

Polymer films of thermoplastic films are widely used for the production of flexible packaging materials. The polymer films are normally produced by simple shaping processes, such as extrusion or blow molding. Because the various requirements a modern packaging film is expected to meet cannot be satisfactorily fulfilled by a polymer film of a single polymer, it has been common practice for some time now to produce so-called composite films, i.e. multilayer films. In order to obtain the three basic properties of a packaging film, such as tear strength, neutral taste and barrier properties, three different processes are currently in use for combining the individual component films to form a composite film:
building up multilayer systems with separate barrier layers by combining polyvinylidene chloride, ethylene/vinyl alcohol and/or aluminium films/foils with polyethylene films, polyester films and/or polyvinyl chloride films. This multilayer system can be produced either by co-extrusion or by bonding separately produced films.
In another process, packaging films, for example based on polyethylene terephthalate or biaxially oriented polypropylene, are coated by vapor deposition (in vacuo) with a layer of aluminium and/or silicon oxide.
Another process uses the surface treatment of flexible packaging films by coating the films with solvent- or water-based polyvinylidene chloride solutions or dispersions, a primer optionally having to be applied in a preliminary process step to achieve firm adhesion of the surface coating to the substrate film.

Thus, WO 98/03332 describes a laminated packaging material for the production of heat-sealable packs for liquid foods, such as milk, cream and juice. This multilayer laminate has a core layer of paper or paperboard, to one side of which a layer of polyethylene (low density polyethylene, LDPE) is applied and which, on the side facing the packaged product, carries an oxygen- and flavor-impermeable barrier layer of ethylene/vinyl alcohol and polyamide. The ethylene/vinyl alcohol and polyamide layers have to directly joined without any adhesive and the extrusion process has to be carried out so that these barrier layers can be fitted onto one another in the molten state and the resulting combination can be applied to the core layer of paper or paperboard. In addition, WO 98/03332 proposes the application of another LDPE layer to the barrier layer using an adhesive. It is clear that this production process is very complicated.

WO 97/42028 describes a multilayer metallized packaging film which comprises a polymer core layer, for example an oriented polypropylene homopolymer (OPP), and—applied to at least one side—a thin polymer layer which has a lower melting temperature than the core layer. The outwardly facing surface of the thin skin layer is then subjected to flame treatment or to corona discharge to increase the adhesion of the metal layer, for example aluminium, subsequently applied. Another polymer layer heat-sealable at low temperature, for example of ethylene/alkyl acrylate or methacrylate copolymers, is applied to the metal layer. According to the document in question, the core layer may be coated with a vinylidene chloride copolymer component using a primer.

WO 97/30847 describes a multilayer packaging film with a barrier effect against oxygen migration. In this thermoplastic multilayer packaging film, the oxygen barrier consists of a core layer containing an ethylene/vinyl alcohol copolymer film, two outer layers and two adhesive layers, the adhesive layers being located between the core layer and the two outer layers. At least one of the outer layers contains a mixture of three components which may be homogeneous or heterogeneous and consists of an ethylene/α-olefin copolymer with a density of 0.195 g/cm² to 0.925 g/cm² and a homogeneous or heterogeneous ethylene/α-olefin copolymer with a density of ≧0.925 g/cm² and a homogeneous or heterogeneous ethylene-α-olefin copolymer with a density of ≦0.915 g/cm². In addition, it is disclosed in the document in question that, in preferred embodiments, the multilayer laminate may comprise additional layers between the adhesive layers and the outer layers. For example, six- or preferably seven-layer films can be produced, in which case the additional layers may either be recycled material or other polymer films, for example polyamide films.

JP 06048474 A2 describes an oxygen-impermeable thermoplastic composite film for packaging foods. This laminate contains a core film, an oxygen barrier layer, an adhesive layer and a layer of a thermoplastic resin containing a metal compound. A polypropylene containing cobalt stearate is proposed as the layer containing a metal compound. The two polypropylene layers are joined by a polyurethane adhesive to a layer of polyvinylidene chloride.

JP-A-63132049 describes laminates consisting of a core layer of an ethylene/vinyl alcohol copolymer or a polyvinyl alcohol layer which is laminated on both sides with a polypropylene layer containing 10 to 70% mica, talcum or calcium carbonate. It is stated that this composite film has a good oxygen barrier effect and high flexural strength.

JP-A-09234811 describes films or sheets which are suitable for storing foods, medicaments or metals and which are said to avoid oxidation of the packaged materials. The films in question are made up of a microporous layer typically containing antioxidants, a nonporous oxygen-permeable thermoplastic layer and a water-insoluble particle-containing, microporous oxygen-permeable thermoplastic layer and optionally other layers. The antioxidant-containing layer is laminated on both sides with the other thermoplastic layers, the whole being joined together by melting.

WO 97/123350 describes polymer films consisting of at least one layer of a thermoplastic polymer to which a layer of a filler in a dispersant is applied. The particulate fillers are said to have a preferably lamellar structure and the dispersant is said to contain a tackifying resin. The filler dispersion can form an outer layer or an inner layer of the film. According to the teaching of this document, the films in question have good barrier effects for oxygen and other gases. It is proposed that the films be used for packaging vegetable materials, such as hay and straw.

The multilayer packaging materials with favorable barrier properties known from the prior art involve complicated production processes. The use of metal layers either by vapor deposition of metal or by lamination of metal films consistently leads in practice to defects in the form of a plurality of tiny holes in the metal layer which seriously impair the otherwise good barrier effect of the metal layer.

Against the background of this prior art, the problem addressed by the present invention was to provide a simple process for the production of composite materials of plastic films which would be distinguished by very good barrier effects, particularly against oxygen, flavors and water vapor.

The solution provided by the invention is defined in the claims and consists essentially in the provision of laminating adhesive compositions based on polymer binders which contain fillers with a platelet-like crystallite structure and an aspect ratio of >100.

The present invention also relates to a process for the production of composite films of at least two identical or different plastic films joined together by a laminating adhesive which contains fillers with a platelet-like crystallite structure and an aspect ratio of >100. The present invention also relates to the use of composite films produced by this process for packaging foods or medicaments.

The direct use of an adhesive in the production of composite materials which, besides bonding the films, also leads to an active barrier against low molecular weight compounds, such as gases, water vapor or flavors, has many advantages:

Laminating the packaging composite to obtain neutrality of taste and printability and the introduction of the barrier properties can be achieved in a single step. There is no need for additional coatings with polyvinylidene chloride and/or ethylene/vinyl alcohol layers or for the vapor deposition of aluminium layers. This reduces the number of production steps and improves the cost/effectiveness ratio of the packaging material. Through the absence of a metal layer, the composite packaging films consist exclusively of plastics and hence are less expensive to dispose of as waste.

The fillers with a platelet-like crystallite structure and aspect ratios of >100 generally have a thickness of only a few nm although the crystallites may be up to a few μm in length or width. Fillers such as these are also known as “nanoparticles”. Through the buildup of labyrinth-like structures of the fillers in the polymer adhesive matrix, the diffusion path of low molecular weight compounds such as, for example, oxygen, water, carbon dioxide, aromas and/or flavors is lengthened so that their migration through the adhesive layer is drastically reduced and, ideally, is stopped altogether.

Suitable compounds for the fillers are oxides, hydroxides, nitrides, halides, carbides or mixed oxide/hydroxide/halide compounds of aluminium, silicon, zirconium, titanium, tin, zinc, iron or alkali(ne earth) metals. These materials are essentially aluminas, for example aluminium oxides, boehmite, bayerite, gibbsite, diaspore and the like. Layer silicates such as, for example, bentonite, montmorillonite, hydrotalcite, hectorite, kaolinite, boehmite, mica, vermiculite or mixtures thereof are most particularly suitable. To improve their dispersibility in the binder matrix, these fillers may be surface-modified with organic compounds.

Suitable binders for these laminating adhesive compositions and dispersion media for the fillers are any one- or two-component laminating adhesive binders known per se, for example hotmelt adhesives and reactive hotmelt adhesives based on polyurethanes. One- or two-component reactive polyurethane adhesives are particularly suitable.

The reactive one-component polyurethane adhesives may be either liquid or paste-form moisture-curing adhesives and also reactive hotmelt adhesives. However, particularly preferred adhesives are two-component adhesives curing at room temperature where one component is a prepolymer containing hydroxyl groups and the second component is a low-volatility polyisocyanate of relatively high molecular weight. The production of such laminating adhesives is described in detail, for example, in DE-A-3401129, or DE-A-44417705. The polyurethane binders described therein for laminating adhesives are expressly part of the present application.

The barrier-effect adhesives according to the invention are suitable for laminating various composite films, i.e. for bonding various plastic films to one another and/or to paper in web form. The plastic films may consist of any the plastics typically used for producing films such as, for example, polyethylene, polypropylene (more particularly oriented polypropylene (OPP) produced by mono- or biaxial stretching), polyester, more particularly polyethylene terephthalate (PET), PVC, polyamide or polyimide. Both the paper webs and the plastic films may be lacquered or printed. Another application for the adhesives according to the invention is the production of bags of blow-molded or woven polyethylene or polypropylene parisons.

The adhesives according to the invention may be applied to the substrates to be bonded by any of the usual processes.

The following Examples are intended to illustrate the invention without limiting it in any way. Unless otherwise indicated, all quantities in the following Examples represent percentages by weight or parts by weight, based on the composition as a whole or on the individual component in the case of two-component adhesives.

### EXAMPLES

20 In the following Examples, a commercially available two-component polyurethane adhesive (Henkel) was modified with the fillers to be used in accordance with the invention. To this end, the filler was dispersed in the hydroxyl-containing component of the polyurethane adhesive Liofol UR 8155 or UR 8156 with the aid of an ultrasonic disperser or a high-speed mixer of the “Ultra Turrax” type. Desmodur N 3300 or Desmodur VP 8712 (Bayer) was used as the isocyanate component. The quantity ratio of the Liofol component to the isocyanate component was selected as recommended by the manufacturer. Two OPP films were bonded to one another and the oxygen transmission rate (OTR) or the water vapor transmission rate (WTR) was measured after curing of the adhesive. The effect barrier effect was determined by comparison with an OPP laminate which had been bonded by a non-filler-containing laminating adhesive with the same composition. As can be seen from the Examples in the following Table, all the modified laminating adhesives according to the invention show a considerable reduction in the oxygen transmission rate.

TABLE 1

| | | | Filling level | Viscosity | | Dispersion | | |
|---|---|---|---|---|---|---|---|---|
| Example | OH component | Nanoparticles¹⁾ | [% by weight]²⁾ | [mPa · s]³⁾ | | method | Laminate/OTR/remarks⁴⁾ | Eff.⁵⁾ |
| 1 | Liofol UR 8156 | — | — | | | | OPP/OPP, Desmodur N 3300 | — |
| | Comparison | | | | | | eff. FL: 0.0% | |
| | | | | | | | OTR: 1480 (1870) | |
| 2 | Liofol UR 8155 | EX 0032 | 10 | 16500 | 6260 | 2.5 mins. | OPP/OPP, Desmodur N 3300 | −23% |
| | | | | | | ultrasound | eff. FL: 5.9% | |
| | | | | | | | OTR: 1140 | |
| 3 | Liofol UR 8155 | EXM 804 | 10 | 6680 | 2310 | 30 s | Desmodur VP 8712 | −49% |
| | | | | | | Ultra-Turrax | eff. FL: 4.6% | |
| | | | | | | | OTR: 190, WTR: 296 | |
| 4 | Liofol UR 8156 | EX 0032 | 10 | 16700 | 5820 | 2.5 mins. | OPP/OPP, Desmodur N 3300 | −27% |
| | | | | | | ultrasound | eff. FL: 5.9% | |
| | | | | | | | OTR: 1080 | |
| 5 | Liofol UR 8156 | Hectorite/benzyl | 10 | 5800 | 1800 | 1.5 mins. | OPP/OPP, Desmodur N 3300 | −35% |
| | | dimethyl-(2-hydroxy- | | | | Ultra-Turrax, | eff. FL: 5.9% | |
| | | ethyl)-ammonium | | | | 2.5 mins. | OTR: 954 | |
| | | | | | | ultrasound | | |
| 6 | Liofol UR 8156 | Hectorite/dodecyl | 10 | 5800 | 1900 | 1.5 mins. | OPP/OPP, Desmodur N 3300, | −42% |
| | | ammonium | | | | Ultra-Turrax | eff. FL: 5.9% | |
| | | | | | | 2.5 mins. | OTR: 853 | |
| | | | | | | ultrasound | | |
| 7 | Liofol UR 8156 | Hectorite/Dehyquart | 10 | 5000 | 1700 | 1.5 mins. | OPP/OPP, Desmodur N 3300, | −52% |
| | | L 80 | | | | Ultra-Turrax | eff. FL: 5.9% | |
| | | | | | | 1.5 mins | OTR: 719 | |
| | | | | | | ultrasound | | |
| 8 | Liofol UR 8156 | Somasif/dodecyl | 10 | 8200 | 2800 | 1.5 mins | OPP/OPP, Desmodur N 3300, | −36% |
| | | ammonium | | | | Ultra-Turrax | eff. FL: 5.9% | |
| | | | | | | 2.5 mins. | OTR: 949 | |
| | | | | | | ultrasound | | |
| 9 | Liofol UR 8156 | Somasif/benzyldim | 10 | 4900 | 1600 | 1.5 mins. | OPP/OPP, Desmodur N 3300 | −16% |
| | | ethyl-(2-hydroxy- | | | | Ultra-Turrax | eff. FL: 5.9% | |
| | | ethyl)-ammonium | | | | 2.5 mins. | OTR: 1237 | |
| | | | | | | ultrasound | | |
| 10 | Liofol UR 8156 | Somasif/Dehyquart | 10 | 5000 | 1500 | 1.5 mins. | OPP/OPP, Desmodur N 3300 | −48% |
| | | L80 | | | | Ultra-Turrax, | eff. FL: 5.9% | |
| | | | | | | 2.5 mins. | OTR: 764 | |
| | | | | | | ultrasound | | |
| 11 | Liofol UR 8156 | Somasif/1,12- | 10 | 5400 | 1800 | 1.5 mins. | OPP/OPP, Desmodur N 3300, | −55% |
| | | diaminododecane | | | | Ultra-Turrax | eff. FL: 5.9% | |
| | | | | | | 2.5 mins. | OTR: 667 | |
| | | | | | | ultrasound | | |
| 12 | Liofol UR 8156 | Nano 2124 | 10 | | | Sand-colored, homo- | OPP/OPP, Desmodur N 3300, | −28% |
| | | | | | | geneously flowable | eff. FL: 5.9% | |
| | | | | | | | OTR: 1060, WTR: 0.91 | |

Remarks:
¹⁾Explanations of the fillers (nanoparticles) in Table 2
²⁾Filling level, based on Liofol UR component
³⁾Brookfield viscosimeter (Thermocell type)
⁴⁾OPP = oriented polypropylene, OTR = oxygen transmission rate, eff. FL = effective filling level of fillers, based on overall adhesive composition
⁵⁾Effectiveness, i.e. reduction of OTR relative to unfilled Comparison Example

TABLE 2
Fillers used

| Filler/modifier | Manufacturer | Modifier |
|---|---|---|
| EX 0032, | Süd-Chemie | C18-n-alkyl/benzyl |
| montmorillonite | | |
| EXM 804, | Süd-Chemie | Term. OH groups |
| montmorillonite | | |
| Somasif, | Co-op Chemical | |
| sodium/magnesium | Co. Ltd., Japan | |
| fluorosilicate | | |
| Dehyquart L80 | Henkel | Bis-(cocyl)-ethyl |
| | | hydroxyethyl methyl |
| | | ammonium methosulfate |
| Nano 2124, | Nanocor | n-Dodecyl pyrrolidone |
| montmorillonite | | |

1-9. (canceled)

10. A laminating adhesive composition based on polymeric binders comprising fillers having a platelet-like crystallite structure and aspect ratios of >100.

11. The laminating adhesive composition of claim 10 wherein the effective filling level of the fillers in the binder matrix is between 0.1 and 30% by weight.

12. The laminating adhesive composition of claim 11 wherein the effective filling level of the fillers in the binder matrix is between 5 and 15% by weight.

13. The laminating adhesive composition of claim 10 wherein the fillers are selected from the group consisting of oxides, hydroxides, nitrides, halides, carbides or mixed oxide/hydroxide/halide compounds of aluminium, silicon, zirconium, titanium, tin, zinc, iron and the alkali(ne earth) metals

14. The laminating adhesive composition of claim 13 wherein the fillers are selected from the group consisting of aluminium oxide, boehmite, bayerite, gibbsite, diaspore, bentonite, montmorillonite, hydrotalcite, hectorite, kaolinite, mica, vermiculite or mixtures thereof.

15. The laminating adhesive composition of claim 10 wherein the binder comprises one- or two-component polyurethane adhesives.

16. The laminating adhesive composition of claim 15 wherein one component of the binder system contains a hydroxyfunctional polymer and fillers and the second component contains polyisocyanate as a hardener.

17. A process for the production of composite films of at least two identical or different plastic films comprising using the composition of claim 10 as the laminating adhesive.

18. A composite film produced by the process of claim 7 having the characteristic of acting as a barrier against the diffusion of oxygen, flavors and/or water vapor.
